(19) United States
(12) Patent Application Publication
(10) Pub. No.: US 2010/0198671 A1
(43) Pub. Date: Aug. 5, 2010

(54) RECYCLING REWARD SYSTEM AND METHOD THEREOF

(75) Inventors: Balaji Prabhakar, Palo Alto, CA (US); Deepak Merugu, Palo Alto, CA (US); Neha Kumar, Berkeley, CA (US)

Correspondence Address: Stanford University, 1705 EL CAMINO REAL, PALO ALTO, CA, 94306, US

(73) Assignee: The Board of Trustees of the Leland Stanford Junior University, Palo Alto, CA (US)

(21) Appl. No.: 12/698,988

(22) Filed: Feb. 2, 2010

Related U.S. Application Data
(60) Provisional application No. 61/149,089, filed on Feb. 2, 2009.

(51) Int. Cl. G06Q 50/00; G06Q 30/00; G06Q 10/00

(52) U.S. Cl. 705/14.16; 705/14.25; 705/308

(57) ABSTRACT

Systems and methods are provided for incentivizing and rewarding consistent and repeated recycling of recyclable materials.

### RELATED APPLICATION

This application claims priority and other benefits from U.S. Provisional Patent Applications Ser. 61/149,089 filed Feb. 2, 2009, entitled “Recycling Reward System and Method Thereof”. Its entire content is specifically incorporated herein by reference.

### TECHNICAL FIELD OF THE INVENTION

The present invention relates to the field of recycling systems and methods for providing and using such systems.

### BACKGROUND

Today, eleven states in the U.S.A. have a container deposit law that requires refundable deposits on certain beverage containers, such as aluminum cans, plastic bottles, etc. This law (also known as the Bottle Bill) provides financial incentives for recycling, thus helping to reduce generation of waste. The deposit amount varies across states, applies to different beverages and is determined by Container Deposit Legislation (Ref. 1).

In California, a redemption value or so-called ‘California Refund Value (CRV)’ of 5 c is added to the cost of beverage containers of less than 24 oz. and 10 c to containers larger than 24 oz. (Ref. 2). This money can be redeemed by consumers when they return the empty containers at a recycling facility. Thus, the empty containers are worth 5 c or 10 c. Last year, Californians bought almost 22 billion carbonated and non-carbonated drinks in aluminum, glass, plastic, and bi-metal containers. More than 14.7 billion of these were recycled, achieving a recycling rate of 67% for the state. Outside of California, however, the rates are not as positive. According to EPA, the country-wide recycling rates of glass containers, plastic soft drink bottles, and aluminum beer and soft drink cans range from 25% to 45%.

When consumers buy beverages in bottles and cans, they act out of self-interest. When they recycle these containers, they are expected to act in the interest of the environment and the earth. The difference in motivations in the two practices determines the large imbalance between the amount consumed and the amount recycled. In order to incentivize recycling and encourage “good” behavior, various efforts have been undertaken in different places across the world. The consumer who pays the deposit value for the container he/she purchases rarely benefits from recycling it. Even if we conservatively estimate that the purchased containers contained less than 24 fl. oz., the numbers sum up to a recycling revenue of approx. USD 735 million for California in 2007. This amount should rightfully be returned to the consumers who paid the CRV. Instead, most often, consumers dispose off their used containers in public bins or via curbside recycling. The monetary benefits do not go to them.

Given the energy savings resulting from a single recycled aluminum can or beverage container, it pays off to reclaim each container. Recycling rates need to be improved world-wide. How can we achieve higher recycling rates? While it is the consumer who pays the container deposit, he/she is unlikely to get this deposit back even if he/she recycles the container depending on whether it was trashed in a public recycling bin or via curbside recycling. Can we ensure that this deposit is returned to the consumer who paid it in the first place?

Taken together, there is a great, currently unmet need for a recycling system and method that provide the framework and financial incentives for consistent and comprehensive recycling of recyclable materials.

### SUMMARY

The present invention addresses the currently unmet need for a recycling system and method that provide the framework and financial incentives for consistent and comprehensive recycling of recyclable materials. Consumers are not incentivized to recycle beverage containers because the effort involved in redeeming the value of the container is not commensurate with the redemption value. To encourage more consumers to recycle the containers that they use, and to reward their efforts toward recycling, we propose a system incorporating a financial incentive scheme and method for implementing consistent and comprehensive recycling.

Embodiments of the present invention describe a recycling system featuring one or more recycling machines including a consumer identification (ID) and an algorithm-based rewarding system, a host server, a data acquisition unit, a network facilitating communication between the recycling machine, the host server and the data acquisition unit; and a network that links and coordinates recycling machines at various places (central hub).

Further embodiments of the present invention describe a method for implementing a system for rewarding consistent and repeated recycling of recyclable materials, which can be effectively used to consistently collect recyclable waste from consumers and for enabling the payout of variable rewards. Other embodiments of the present invention describe a method for recycling recyclable materials using a system for rewarding consistent and repeated recycling of recyclable materials.

The system for rewarding consistent and repeated recycling of recyclable materials, in accordance with embodiments of the present invention, is based on the theory of expected utility maximization and, together with the proposed recycling system, aims to use the intrinsic value of recyclables to incentivize consumers to recycle. The combination of an efficient collection system and an attractive financial incentive scheme will help to increase the recycling rates and benefit the consumers directly. The above summary is not intended to include all features and aspects of the present invention nor does it imply that the invention must include all features and aspects discussed in this summary.

### INCORPORATION BY REFERENCE

All publications and patent applications mentioned in this specification are herein incorporated by reference to the same extent as if each individual publication or patent application was specifically and individually indicated to be incorporated by reference.

### DRAWINGS

The accompanying drawings illustrate embodiments of the invention and, together with the description, serve to explain the invention. These drawings are offered by way of illustration and not by way of limitation; it is emphasized that the various features of the drawings may not be to-scale.

FIG. 1 depicts a system for rewarding consistent and repeated recycling of recyclable materials in accordance with one embodiment of the present invention. Generally, the system comprises (a) a recycling machine featuring a display and user interface; ID card reader, cash collection outlet as well as slots for recycling various recyclable materials such as glass, plastics, aluminum, electronic waste (e-waste) such as batteries, and other materials such as biodegradable materials; (b) a host server; (c) a data acquisition unit; (d) a network facilitating communication between the recycling machine, the host server and the data acquisition unit and (e) a central hub that links and coordinates recycling machines at various places.

FIG. 2 depicts an exemplary recycling machine in accordance to one embodiment of the present invention.

FIG. 3 illustrates an exemplary network of recycling machines connected to a central hub in accordance with another embodiment of the present invention.

FIG. 4 is a flow diagram illustrating a method for implementing a system for rewarding consistent and repeated recycling of recyclable materials, in accordance with an embodiment of the present invention.

FIG. 5 is a flow diagram illustrating a method for recycling recyclable materials using a system for rewarding consistent and repeated recycling of recyclable materials, in accordance with an embodiment of the present invention.

### DEFINITIONS

Unless defined otherwise, all technical terms used herein have the same meaning as commonly understood by a person of ordinary skill in the art to which this invention belongs. The following definitions are intended to also include their various grammatical forms, where applicable.

The term “recyclable”, as used herein, refers to any material which can be processed or otherwise altered in order to recover used or deteriorated material. Those materials include, but are not limited to plastics, glass, paper, cardboard, metals, electronic waste, textiles, organic matter and any other suitable material in accordance with embodiments of the present invention.

The term “reward”, as used herein, encompasses direct as well as indirect monetary rewards, whereby direct monetary reward is characterized by direct monetary payout at the recycling machine and whereby indirect monetary reward is characterized by redemption for gift certificates, goods, services instead of direct monetary payout.

The term “central hub”, as used herein, refers to a device for connecting multiple recycling machines and making them function as a single device.

The terms “user” and “consumer” are used interchangeably and refer to an individual who actively engages in recycling of recyclable materials.

### DETAILED DESCRIPTION

As mentioned in the background section, each beverage container that is sold in California has an intrinsic value of 5 cents (c) or 10 c that can be redeemed by consumers upon recycling those empty containers. The described algorithm is based on the theory of expected utility maximization and, together with the proposed recycling system, aims to use this intrinsic value of the empty containers to incentivize consumers to recycle. We believe that the combination of an efficient collection system and an attractive financial incentive scheme will help to increase the recycling rates and benefit the consumers directly.

At the heart of our approach is the following train of thought. A single can obtains a refund of just 5 c and hence isn't considered worth making the effort to recycle. Consumers simply factor this amount into the cost of the beverage and discard the empty can. If, by some means, the potential refund from recycling a can be increased to a much larger amount, for example to $5 or to $500, then a consumer can be heavily incentivized to recycle the can and claim the refund. However, since it would be absurd to levy a redemption value of $5 or $500 for a soda can which currently costs about $0.50, we must find a way within the current system which charges a CRV of 5 c per can to make the large payouts of, for example, $5 and $500.

For ease of exposition, we assume that the refund value of a container is 5 c. We propose to make the payout of the redemption value a random variable with a mean value of 5 c. For example, a consumer who returns a can is offered the following choice of payouts: (i) 5 c guaranteed, (ii) $0.50, with 10% chance and $0 otherwise, (iii) $50 with 0.1% chance and $0 otherwise, (iv) $500 with 0.01% chance and $0 else, etc. In all cases the expected payout is 5 c, but the upside is progressively higher. As discussed in the economics literature, consumers may well choose the higher payouts, even though the corresponding payouts have a higher variance. Essentially this is due to very low downside (loss of 5 c) compared with the high potential upside.

System for Rewarding Consistent and Repeated Recycling of Recyclable Materials, Comprising a Plurality of Recycling Machines; a Consumer Identification and Rewarding System; and a Central Network that Interconnects and Coordinates Said Recycling Machines

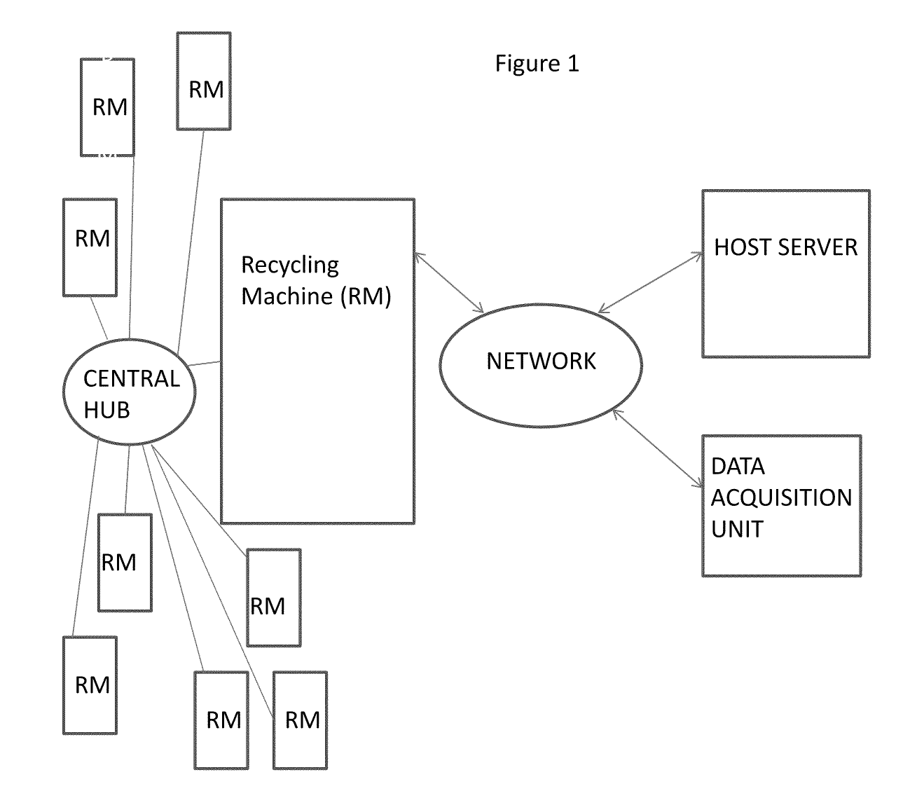

Embodiments of the invention describe an accessible distributed recycling system featuring a reward scheme to further incentivize good recycling practices among consumers. As illustrated in FIG. 1, this system comprises the following units:
1. A recycling machine including a consumer identification (ID) and an algorithm-based rewarding system;
2. a host server;
3. a data acquisition unit;
4. a network facilitating communication between the recycling machine, the host server and the data acquisition unit; and
5. a network that links and coordinates recycling machines at various places (central hub).

Recycling machine

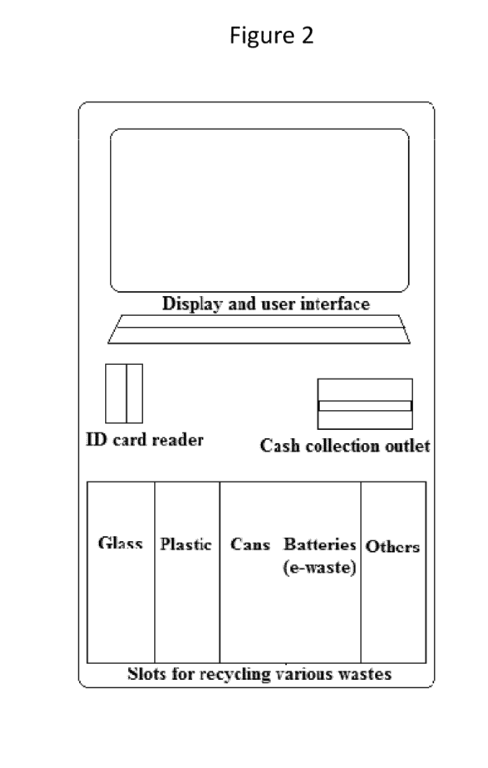

The recycling machine is the unit which directly interacts with the consumers, collects the recyclable trash and processes it for delivery to the recycler. These machines can be widely deployed inside or outside of stores, restaurants, near or within shopping centers and other public places where recyclable waste can be expected from the consumers and subjected to a scheduled pickup, removal and/or storage off-site of the collected recyclable materials by, for example, a garbage/recycling company. Furthermore, recycling machine can also be situated inside or outside of private homes and subjected to a scheduled pickup, removal and/or storage off-site of the collected recyclable materials by, for example, a garbage/recycling company. An exemplary recycling machine is depicted in FIG. 2.

The recycling machine can have multiple slots for accepting different kinds of wastes such as glass; various kinds of plastic; aluminum materials such as aluminum cans; electronic waste (e-waste) such as batteries, lightbulbs, small electronic devices; wood-based waste such as paper, cartons; various kinds of metals; textile-based materials; and other wastes such as organic materials including but not limited to biodegradable and compostable materials which can potentially have some redemption value in the future.

The machine can recognize the inserted units, sort them into the respective bins and quantify according to counting and/or weight. It can also detect and reject improper units. The machine can process the recyclables inserted (for e.g. crush/slice) for compactness and ease of delivery. The machine has a display (for e.g. LCD screen) which shows the current number of units of each type, the number of additional units it can accommodate and other useful information. The machine also has a network communication device through which it is connected to the recycling network. It receives/sends management, status and other information from/to the network. The machine has a payout unit through which it can either deliver direct cash or equivalent valuables to the consumer or add the appropriate credit to the consumer's account for later redemption.

The machine can identify a consumer according to his/her recycler ID, which can be a numeric passcode or a physical consumer identification card to be swiped in the card reader. The identification mechanism facilitates the consumer account management and credit update and redemption. The machines may also host product advertising. As the machines are connected to a network, they can also screen product advertisements. This helps in generating side income which can offset the initial investment and later be used to reward the consumers.

Furthermore, the recycling machine can be a potentially smaller unit for use at home, where each household pays a subsidized fixed one-time amount for the provision of a recycling machine which quantifies (by counting and/or weight) and processes recyclables. Such recycling machines for home-based use are also network-connected and kept up-to-date via a central hub network. Each household has a designated passcode for redemption of points. This pass code can be used to login to an online interface to redeem the appropriate reward. Over time, the consumer will get back the value of the recycling machine that he/she paid, and more.

Consumer Identification and Rewarding System

The consumers who recycle their recycables at the recycling machines are identified using a recycler identification (ID). The ID can be a numeric passcode or a physical identification card. The identification information is located in a central database which is shared by all machines using the network. Thus, a consumer is identified not only by his local machine, but by any machine that is connected to the network. Consumer identification helps the system to track their history. It also facilitates the system to maintain an account for every consumer. Thus, instead of collecting his reward right away, a consumer might want to redeem it later (for e.g. a bigger reward). In such a case, the appropriate credit is added to the consumer's account which can be redeemed at any location of his choice in the future. The system may also identify groups (with group IDs similar to individual IDs) wherein the members can pool their credits and share the reward thus received.

Cash Collection Outlet

A reward can be paid out directly as cash to the consumer via the cash collection outlet.

Algorithm-Based Rewarding System

Embodiments of the invention incorporate an algorithm where the refund value is made a random variable with an expected value of, for example, 5 c. Thus, for example, a recycler is given the following choice of refunds: (i) 5 c, (ii) $5 with 1% chance, or (iii) $500 with 0.01% chance. He/she may find the higher rewards very attractive, even though they may have a small chance of being awarded.

In particular embodiments of the invention, the algorithm further describes a frequent recyler program which qualifies frequent recyclers to (i) earn rewards with a higher chance, and (ii) to earn higher rewards. Thus, for example, if A has 100 unredeemed recyclables and B has 10 to their credit, then A may be qualified to rewards of up to $500, whereas B may only be qualified for a maximum of $50. Moreover, A may be offered the $5 reward at 1.1% chance, whereas B may be offered the $5 reward at 0.9% chance.

In further embodiments of the invention, the algorithm describes a “recommend a friend” program by which A, who is already part of the recycling program, recommends a new recycler B to the program, and whenever B recycles a container, A earns some credit. For example, when B recycles a container, he/she earns a 5 c credit and A earns a 1 c credit. We shall also consider a “group program” where a group of individuals share the responsibility of recycling and earn credits together. This allows the group to obtain a large amount of credit quickly, making it possible for the group to receive the benefits of the frequent recycler program described above.

In some embodiments of the invention, the algorithm which returns random amounts of reward may aim to: (i) balance the budget, which means all sums of money collected through recyclables are returned to the consumers; (ii) retain some money, which means the total money returned is less than that collected through the recyclables; for example, 4 c on average is returned per recyclable. The money retained could be used to offset the cost of operating the recycling system; (iii) Return more money than is collected from the recyclables; for example, 6 c on average is returned per recyclable. The extra money may be provided by corporations or other entities interested in promoting recycling.

Host Server

A server to communicate with the recycling machines via the network, retrieve user information, update their records in the database, receive information from recycling machines when the storage is close to full, etc. The server could also send important information to the recycling machines e.g. conveying information about other recycling machines nearby, serving relevant advertisements.

Data Acquisition Unit

The unit consists of a database to store user records, statistics and several other information. It is maintained and controlled by the server directly or via the network.

Network facilitating communication between the recycling machine, the host server and the data acquisition unit

A wired and/or wireless network, more likely internet, to enable communication between various entities. Every entity (recycling machine, host server and/or data acquisition unit) will be connected to the network through a network interface hardware. This will then enable them to communicate the information. The network bandwidth requirements are very reasonable as we do not expect to have heavy data traffic on the network links.

Network that links and coordinates recycling machines at various places (central hub)

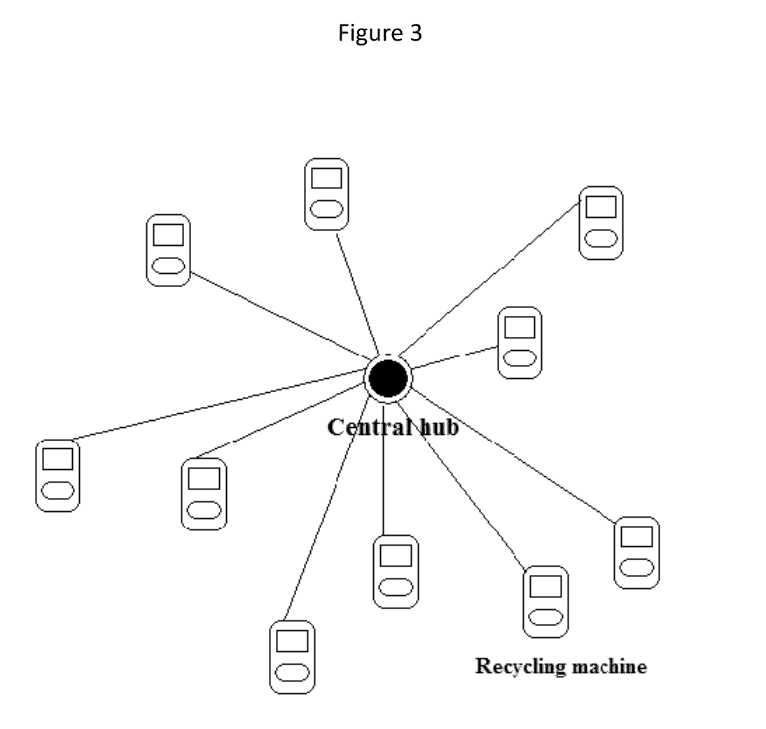

A network connects all the recycling machines to a central system or central hub, as depicted in FIG. 3. There are several advantages of networking the recycling machines. It helps in having a centralized control and management of all the machines. It also enables the consumers to recycle at any machine connected to the network, whether at a public place or at home, as explained above. By sharing the database of the central system, the machines can readily identify the consumers and, thus, provide a user-convenient service. The machines can also offload computational tasks to the central system, reducing the cost of the machines.

The network connects all the recycling machines to a central system. It also maintains and manages the machines remotely from the central system. The network helps in distributively collecting the recyclables from many locations. The central system maintains a collective database of all the consumers. The network helps in maintaining and updating the consumer credit histories and reward/payout histories (both individual and group).The network also helps the system in maintaining the machine accounts and histories. The network helps the central system receive status updates from various machines and, thus, help in managing the machines. The network communicates with the machines and informs the system if a machine needs to be emptied or refilled with cash/valuables.

The network also continuously sends the information to be displayed by the recycling machines. It may redirect the consumers to other nearby machines when a particular machine is full with recyclables or has no more cash/valuables to dispense. The network could be a wireless network or a network connected via Ethernet or a telephone line or a mixed network, so that it only requires minimal cost of set-up/infrastructure.

Method for Implementing a System for Rewarding Consistent and Repeated Recycling of Recyclable Materials, Comprising a Plurality of Recycling Machines; a Consumer Identification and Rewarding System; and a Central Network that Interconnects and Coordinates Said Recycling Machines

Recycling systems in accordance to embodiments of the present invention can be implemented in many various ways, at public places such as shops, restaurant, shopping malls and at private homes. In either case, the method for implementing a recycling system, as described, includes the provision and use of a recycler identification (ID) as well as the provision and use of a recycling system, that features a consumer identification (ID), an algorithm-based incentive scheme, a host server, a data acquisition unit, a network facilitating communication between the recycling machine, the host server and the data acquisition unit; and a network that links and coordinates recycling machines at various places (central hub) including public places and private homes.

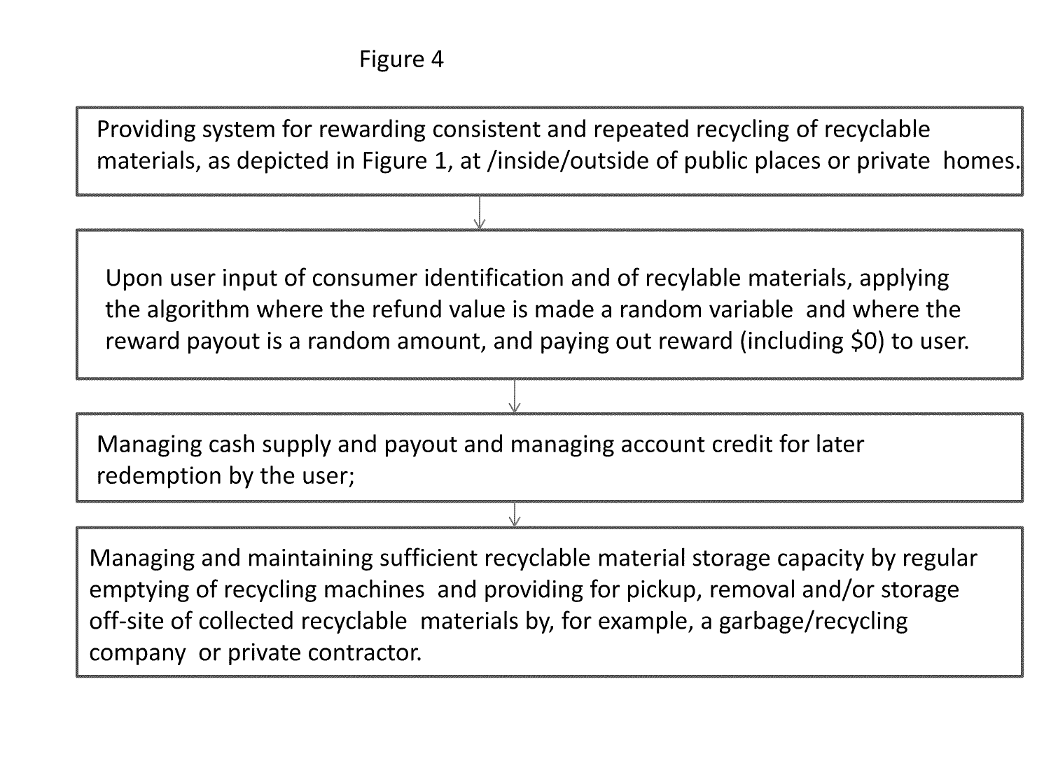

The method for implementing a system for rewarding consistent and repeated recycling of recyclable materials, as illustrated in FIG. 4, further includes the managing of cash supply to ensure that the recycling machines are kept operative with sufficient cash to dispense as well as the managing of accurate account credits for later redemption by the user including the continuous updating of the user's account. The method for implementing such a system also includes the managing and maintaining of sufficient storage capacity for recyclable materials to avoid overfilling and interruption of service through regular emptying of the recycling machines and provision of removal of the recyclable materials to make room for new, to-be-deposited recyclable materials.

Method for Recycling Recyclable Materials Using a System for Rewarding Consistent and Repeated Recycling of Recyclable Materials, Comprising a Plurality of Recycling Machines; a Consumer Identification and Rewarding System; and a Central Network that Interconnects and Coordinates Said Recycling Machines

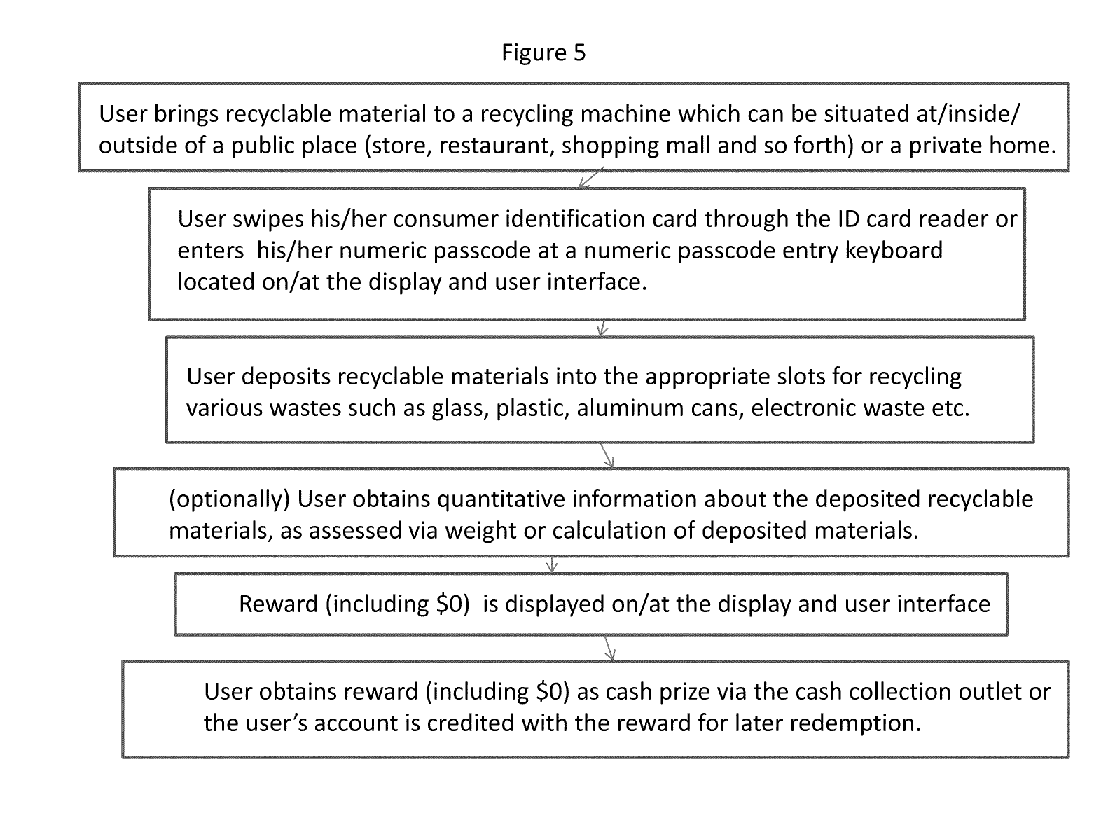

FIG. 5 is a flow diagram illustrating the method of recycling recyclable materials using a system for rewarding consistent and repeated recycling of recyclable materials, in accordance with embodiments of the present invention. For reasons of practicality and convenience, the flow diagram of FIG. 5 is described with reference to FIG. 2, which depicts an exemplary recycling machine in accordance to one embodiment of the present invention.

The method of recycling recyclable materials using a system for rewarding consistent and repeated recycling of recyclable materials starts with the user bringing recyclable materials to a recycling machine which can be situated at/inside/outside of a public place (store, restaurant, shopping mall and so forth) or a private home. Next, the user swipes his/her consumer identification card through the ID card reader at the recycling machine or enters his/her numeric passcode at a numeric passcode entry keyboard located on/at the display and user interface of the recycling machine. The user then deposits the recyclable materials into the appropriate slots for recycling various wastes such as glass, plastic, aluminum cans, electronic waste and so forth.

Optionally and upon request, the user obtains then quantitative information about the number of deposited recyclable materials, as assessed via weight or calculation of deposited materials. Furthermore, the reward (including $0) is displayed on/at the display and user interface of the recycling machine. Finally, the user obtains the reward (including $0) as a cash prize via the cash collection outlet or the user's account is credited with the reward for later redemption.

The user can optionally be enrolled in a “frequent recycler” program or “recommend a friend” program. The “frequent recycler” program is implemented by the algorithm-based incentive scheme in accordance with the amount of recycling done by a particular user. The more he/she recycles, the more favorable will be his odds of winning or possibly a slightly more deterministic reward. The goal of this program is to offer better incentives for higher recycling. The “recommend a friend” program aims to increase recycling levels by bringing in more recyclers. Users who refer their friends will derive additional (bonus) benefits e.g. credits, when their friends register and start recycling. They may also be awarded a small fraction of the credits earned by the referred users as bonus.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope.

In the following, examples will be described to illustrate parts of the invention.

### EXAMPLES

The following examples are put forth so as to provide those of ordinary skill in the art with a complete disclosure and description of how to make and use the present invention; they are not intended to limit the scope of what the inventors regard as their invention.

### Example 1

### Evaluating Games with Random Payoffs

When presented with different choices, a rational person would like to make an informed, intelligent choice. When considering games with random payoffs, some natural questions a player may ask are: “Why should I be interested in random rewards?” and “How can I decide how much to bet?” These questions are clearly pertinent to a consumer whose recycling habits our algorithm aims to encourage. The systematic study of these questions is undertaken in the branch of economic theory known as the Expected Utility Maximization theory. We shall see that for games with low stakes where this theory obtains that players tend to be more risk neutral as opposed to being risk averse. In the context of recycling rewards this means recyclers will likely choose to seek refunds that have a high value even though such refunds have a small chance of being awarded.

Since, as assumed at the outset to illustrate an example, the value of a recyclable is 5 c, a very small stake indeed, the result stated above is directly relevant. It is instructive to consider an example which serves to motivate and to explain the formal mathematical results. A person is given two choices, A and B, say. If he chooses A, he gets a fixed reward of $2. On the other hand, if he chooses B, he will be given a reward of $100 with a 10% chance and $0 otherwise. Thus, the average value of the reward is $10. Even though the expected reward is higher for the second choice, it has a potential risk where the person might effectively lose $2. What should the person choose?

Enter utility functions. Say that our player has a utility function, U(x), which is the value he/she attaches to a wealth of $x. The function U(x) has the following properties: (i) U(x) increases as x increases, capturing the fact that people attach more value to higher wealth. (ii) U(x) is concave; that is, the marginal value of additional wealth decreases as the current wealth increases. For example, $100 is far more valuable to a person whose wealth equals $100 than to a person whose wealth equals $1,000.000. We shall also assume, without loss of generality that (iii) U(0)=0. The theory of expected utility maximization posits that a person chooses the option which maximizes their expected utility. In our example, the person will choose A if U(2)>0:1U(100)+0:9U(0)=0:1U(100); otherwise, they will choose B.

In order to understand the choice players will make in games of low stakes, suppose that the player of our game chooses option B. Will they automatically also choose B in the game: A gives a $1 reward and B gives $50 with 10% chance? Another question: Will they choose B in the game: A gives a $1 reward and B gives $20 with 10% chance? If the answer to this second question is “yes” then it says that, as the stakes get lower, a player is willing to take the same risk for smaller average reward. Or, that they become more risk neutral. As is known in the economics literature, the answers to the above questions are not in the affirmative for all increasing, concave utility functions. More conditions, such as listed in Conditions 1 and 2, are needed.

We show that if U(x) satisfies one of the following two conditions, then players become more risk neutral as the stakes are lowered. The original file is written in LaTex™.

(a) $\frac{−x U″(x)}{U′(x)}\geq 1$ on $[x_{—}0, \infty)$ for some $x_{—}0$ and (b) $\frac{xU′(x)}{U(x)}$ is non-increasing in $x$ on $[x_{—}0,\infty)$ for some $x_{—}0$. We shall see that condition (a) implies condition (b). Thus, condition (b) is more general; however, condition (a) is better-known in the literature. \noindent{\bf Condition 1.} Let $U(x)$ be a utility function satisfying $\frac{−x U″(x)}{U′(x)}\geq 1$ for $x\geq x_{—}0$, for some $x_{—}0 \geq 0$. Then $xU'(x)/U(x)$ is a monotone non-increasing function for $x\geq x_{—}0$. If $U(x)$ is strictly concave, then $xU'(x)/U(x)$ is a strictly decreasing function for $x\geq x_{—}0$. \noindent{\em Remark.} The function $\frac {−x U″(x)}{U′(x)}$ is called the relative risk aversion function in the economics literature.

\noindent \textbf{Proof:} Consider the expression $U(x)[Û{\prime}(x)+xÛ{\prime\prime}(x)]−xÛ{\prime}(x)̂2$ for $x \geq x_{—}0$. We have: \begin{eqnarray*} % \nonumber to remove numbering (before each equation) U(x)[Û{\prime}(x)+xÛ{\prime\prime}(x)]−xÛ{\prime}(x)̂2 &=& U(x)U(x)[1+xU″(x)/U′(x)]−xU(x)̂2\\ & \leq & 0 \end{eqnarray*} $(\because Û{\prime}(x) \geq 0, −xÛ{\prime\prime}(xÛ{\prime}(x)\geq 1$ for $x \geq x_{—}0)$ \noindent $\therefore \frac{d}{dx}(xÛ{\prime}(x)/U(x))=[U(x)(Û{\prime}(x)+xÛ{\prime\prime}(x))−xÛ{\prime}(x)̂2]U(x)̂2 \leq 0$ $\forall$ $x \geq x_{—}0$ \vspace{0.5pc}\\\$\Rightarrow xÛ{\prime}(x)/U(x)$ is a monotone non-increasing function for $x\geq x_{—}0$. \mbox{ }\hfill$\Box$.

\noindent{\bf Condition 2:} Let $U(x)$ be a utility function such that $xU′(x)/U(x)$ is a non-increasing function of $x$ on $[\beta w, \infty)$ for some $w$ and $\beta<1$. A player with this utility function is offered the choices: (i) $\$w$, (ii) $\$w_{—}1 (w_{—}1>w)$ with probability $p$ and \$0 otherwise. If he choose option (ii), then he will also choose to win $\$\beta w_{—}1$ with probability $p$ over a fixed return of $\beta w$. More formally: $pU(w_{—}1)>U(w) \Rightarrow pU(\beta w_{—}1)>U(\beta w)$. \noindent{\em Remark.} Note that the utility functions satisfying $\frac{−x U″(x)}{U(x)}\geq 1$ on $[\beta w, \infty)$ also have the property that $xU′(x)/U(x)$ is a non-increasing function of $x$ on $[\beta w, \infty)$ by Condition 1. Thus, the class of functions satisfying the requirements for Condition 2 is a bigger class which includes the functions satisfying the requirements for Condition 1.

\noindent{\bf Proof:} We have: \vspace{0.5pc}\ \\$xÛ{\prime} (x)/U(x)$ is a non-increasing function of $x$ on $[\beta w, \infty)$ \vspace{0.5pc}\ \\$\Rightarrow \alpha w_{—}1Û{\prime}(\alpha w_{—}1)/U(\alpha w_{—}1) \leq\alpha Û{\prime}(\alpha w)/U(\alpha w)$ $\forall$ $\alpha \geq \beta $ $(\because w_{—}1>w)$ \vspace{0.5pc}\ \\$\Rightarrow U(\alpha w)Û{\prime} (\alpha w_{—}1)w_{—}1\leq U(\alphaw_{—}1)Û{\prime}(\alpha w)w$ $\forall$ $\alpha \geq \beta$ \vspace{0.5pc} \ \\$\Rightarrow \frac{d}{d\alpha}(U(\alpha w_{—}1)/U({\alpha}w))=[U(\alpha w)Û{\prime}(\alpha w_{—}1)w_{—}1−U(\alphaw_{—}1)Û{\prime}(\alpha w)w]/U({\alpha}w)̂2 \leq 0$ \vspace{0.5pc}\ \\$ \forall$ $\alpha \geq \beta$ \vspace{0.5pc} \ \\$\Rightarrow U(\alpha w_{—}1)/U({\alpha}w)$ is a non-increasing function of $\alpha$ on $[\beta,\infty)$ \vspace{0.5pc}\ \\$\Rightarrow U(\beta w_{—}1)/U(\beta w) \geq U(w_{—}1)/U(w)$ $(\because \beta<1)$ \vspace{0.5pc}\ \\$\Rightarrow pU(\beta w_{—}1)/U(\beta w) \geq pU(w_{—}1)/U(w)>1$ $ (\because pU(w_{—}1)>U(w))$ \vspace{0.5pc}\ \\$\Rightarrow pU(\beta w_{—}1)>U(\beta w)$. Thus, the person will accept the lower bet. \mbox{ }\hfill$\Box$ \vspace{1pc}.

\noindent\textbf{Corollary:} The person will also accept the bet of winning $\alpha w_{—}1$ with the same chance $p$ over getting a fixed return of $\beta w$, where $\alpha \in [\alpha_{—}0, \beta]$ for some $\alpha_{—}0 \leq \beta$. More formally: $ pU(\alpha w_{—}1)>U(\beta w)$$\forall \alpha \in [\alpha_{—}0, \beta]$ for some $\alpha_{—}0 \leq\beta$\noindent \textbf{Proof:} From the previous proof, we observe that: \vspace{0.5pc}\ \\$U(\beta w_{—}1)/U(\beta w) \geq U(w_{—}1)/U(w)$ \vspace{0.5pc}\ \\$\Rightarrow U(\beta w_{—}1) \geq U(\beta w)U(w_{—}1)/U(w)$ \vspace{0.5pc}\ \\$\Rightarrow \exists \alpha_{—}0 \leq \beta$ s.t. $U(\alpha_{—}0w_{—}1)=U(\beta w)U(w_{—}1)/U(w)$ $(\because U(x)$ is a monotonic increasing function of $x$)\vspace{0.5pc}\ \\$\Rightarrow U(\alpha w_{—}1) \geq U(\beta w)U(w_{—}1)/U(w)$ $\forall \alpha \in [\alpha_{—}0, \beta]$ \vspace{0.5pc} \ \\$\Rightarrow pU(\alpha w_{—}1)/U(\beta w) \geq pU(w_{—}1)/U(w)>1$ $\forall \alpha \in [\alpha_{—}0, \beta]$ \vspace{0.5pc}\ \\ $\Rightarrow pU(\alpha w_{—}1)/U(\beta w)>1$ $\forall \alpha \in [\alpha_{—}0, \beta]$ \mbox{ }\hfill$\Box$ \vspace{1pc}\.

As mentioned earlier, not all utility functions satisfy the hypothesis of Condition 2. But most of the common utility functions meet these requirements, making the class of such functions big enough for all practical purposes. It is, however, an interesting theoretical question to find the biggest class of functions for which Condition 2 holds.

### Example 2

### Illustrative Example with a Specific Utility Function

Consider a player whose utility function is $U(x)=log(1+0.1x)$. Note that this function satisfies the requirements of Condition 2. We will now consider various cases where the person is offered different choices and check if he is willing to accept the variable reward over the fixed return.

Case (i): Let us consider the earlier example with the following set of choices: a fixed return of \$2 versus a variable return of \$100 with a 10\% chance and \$0 with a 90\% chance. Thus, the average variable return is \$10. The expected utility for the choice of fixed return is $U(2)=0.182$. The expected utility for the second choice is $0.1U(100)=0.240>0.182$. Hence, the user will accept the bet.

Case (ii): The bet is: a fixed return of \$1 versus a variable return of \$50 with a 10\% chance and \$0 with a 90\% chance. By Condition 2, we know that the user will accept the bet. Indeed, $U(1)=0.095<0.179=0.1 U(50)$.

Case (iii): Now consider the following bet in which the winning amount is lower than the prorated amount: a fixed return of \$1 versus a variable return of \$20 with a 10\% chance and \$0 with a 90\% chance. Thus, the average variable return is \$2. The expected utility for the choice of fixed return is $U(1)=0.095$. The expected utility for the second choice is $0.1U(20)=0.110>0.095$ and so, the user will also accept this lower bet—verifying the corollary to Condition 2.

Case (iv): Let us now consider another interesting case. Suppose the person is offered the same amounts as in case (i), but now with a winning chance of 6\% (as opposed to 10\%). Thus, the average variable return is \$6. The expected utility for the choice of fixed return is $U(2)=0.182$. The expected utility for the second choice is $0.06U(100)=0.144<0.182$. Thus, the person will not accept the bet and chooses the fixed return. Suppose now the stakes are scaled down as in case (ii) but with the same winning chance of 6\%. The average variable return now is \$3. The expected utility for the choice of fixed return is $U(1)=0.095$. The expected utility for the second choice is $0.06U(50)=0.108>0.095$ and hence, the person accepts the bet in this case. This shows that the users tend to be less risk averse or more risk neutral as the stakes are lowered.

### REFERENCES

(1) Container Deposit Legislation: http://en.wikipedia.org/wiki/Container deposit legislation;
(2) AB 3056: Frequently Asked Questions—Department of Conservation, California: http://www.conservation.ca.gov/dor/notices/Pages/ab3056faqs.aspx.

What is claimed is:

1. A system for rewarding consistent and repeated recycling of recyclable materials, comprising one or more recycling machines including a consumer identification (ID) and an algorithm-based rewarding system; a host server; a data acquisition unit; a network facilitating communication between the recycling machine, the host server and the data acquisition unit; and a network that links and coordinates recycling machines at various places (central hub).

2. The system of claim 1, wherein said consumer identification and rewarding system is based on a financial incentive scheme whereby the payout of the redemption value is a random variable.

3. The system of claim 1, wherein said consumer identification and rewarding system encompasses frequent recycler as well as “recommend a friend” programs.

4. The system of claim 1, wherein the recycling machines are situated inside or outside of stores, restaurants, near or within shopping centers and other public places where recyclable waste can be expected from consumers.

5. The system of claim 1, wherein the recycling machines are situated inside or outside of a private home.

6. A method for implementing a system for rewarding consistent and repeated recycling of recyclable materials, comprising one or more recycling machines including a consumer identification (ID) and an algorithm-based rewarding system; a host server;
a data acquisition unit; a network facilitating communication between the recycling machine, the host server and the data acquisition unit; and a network that links and coordinates recycling machines at various places (central hub).

7. The method according to claim 6, wherein said consumer identification and rewarding system is based on a financial incentive scheme whereby the payout of the redemption value is a random variable.

8. The method according to claim 6, wherein said consumer identification and rewarding system encompasses frequent recycler as well as “recommend a friend” programs.

9. The method according to claim 6, wherein the recycling machines are situated inside or outside of stores, restaurants, near or within shopping centers and other public places where recyclable waste can be expected from consumers.

10. The method according to claim 6, wherein the recycling machines are situated inside or outside of a private home.

11. A method for recycling recyclable materials using a system for rewarding consistent and repeated recycling of recyclable materials, comprising one or more recycling machines including a consumer identification (ID) and an algorithm-based rewarding system; a host server; a data acquisition unit; a network facilitating communication between the recycling machine, the host server and the data acquisition unit; and a network that links and coordinates recycling machines at various places (central hub).

12. The method according to claim 11, wherein said consumer identification and rewarding system is based on a financial incentive scheme whereby the payout of the redemption value is a random variable.

13. The method according to claim 11, wherein said consumer identification and rewarding system encompasses frequent recycler as well as “recommend a friend” programs.

14. The method according to claim 11, wherein the recycling machines are situated inside or outside of stores, restaurants, near or within shopping centers and other public places where recyclable waste can be expected from consumers.

15. The method according to claim 11, wherein the recycling machines are situated inside or outside of a private home.
